(19) United States
(12) Patent Application Publication
(10) Pub. No.: US 2026/0249673 A1
(43) Pub. Date: Aug. 27, 2026

(54) MULTI-LAYER ASSEMBLY FOR BATTERY PROTECTION FROM A GROUND STRIKE

(71) Applicant: Rivian IP Holdings, LLC, Irvine, CA (US)

(72) Inventors: Tripur Udhav MAHAJAN, Irvine, CA (US); Adam Richard BALLARD, Corona, CA (US); Sharbel ELKANTATI, Windsor (CA)

(21) Appl. No.: 19/064,532

(22) Filed: Feb. 26, 2025

(51) Int. Cl. B60K 1/04; H01M 50/204; H01M 50/242; H01M 50/249; H01M 50/262

(52) U.S. Cl. CPC B60K 1/04; H01M 50/204; H01M 50/242; H01M 50/249; H01M 50/262; B60K 2001/0438; H01M 2220/20

(57) ABSTRACT

A tray is used to provide protection to a battery pack (including one or more battery modules) against grounds strikes. The tray may include various portions designed to provide reinforcement to enhance the stiffness of the tray. The tray may include one or more modulated portions. Additionally, the tray may include one or plates, as well as a panel positioned between the tray and one of the plates.

### INTRODUCTION

Batteries are often used as a source of power, including as a source of power for electric vehicles that include wheels that are driven by an electric motor that receives power from the batteries. A battery may include several battery cells carried within a module and/or a carrier.

### SUMMARY

The subject technology is directed to a tray for a battery pack. The tray may be reinforced with various structural enhancements, such as a modulated (e.g., corrugated) portion(s) as well as additional structural components (e.g., corrugated panel, doubler plate).

In at least one aspect of the present disclosure, an apparatus is described. The apparatus may include a tray configured to couple with an enclosure for a battery pack. The tray may include a first modulated portion. The tray may further include a planar portion separate from the first modulated portion. The apparatus may further include a panel coupled with the tray at the planar portion. The panel may define a second modulated portion. The apparatus may further include a first doubler plate that covers the panel.

The tray may include a first wall. The first doubler plate may include a second wall welded to the first wall. The first wall may surround the first modulated portion and the planar portion. The first wall may include a diagonal wall.

The apparatus may further include a second doubler plate coupled to the tray at the first modulated portion. The panel may be welded to the planar portion.

The first modulated portion may include a plurality of ribs. The plurality of ribs may include a first rib having a first width. The plurality of ribs may further include a second rib having a second width different from the first width. The first width may be greater than the second width. The first rib may include an opening configured to receive a fastener. The tray may define an asymmetric body based on the first modulated portion and the planar portion.

In at least another aspect of the present disclosure, a battery subassembly is described. The battery subassembly may include an enclosure configured to cover one or more battery cells. a tray coupled with the enclosure. The tray may include a first surface that faces the enclosure. The first surface may define i) a first modulated portion and ii) a planar portion separate from the first modulated portion. The tray may further include a second surface opposite the first surface. The enclosure and the tray may combine to enclose the one or more battery cells. The battery subassembly may further include a skid plate coupled with the tray at the second surface.

The battery subassembly may further include a panel coupled with the tray at the planar portion. The panel may define a second modulated portion. The battery subassembly may further include a first doubler plate that covers the panel.

The battery subassembly may further include a second doubler plate coupled to the tray and covering the first surface at the first modulated portion. The tray may further include a first wall. The first doubler plate may include a second wall welded to the first wall. The first wall may include a diagonal wall. The tray further may further include a flange portion extending from the diagonal wall and coupled with the enclosure.

The first modulated portion may define a corrugated portion having a plurality of ribs. The plurality of ribs may include a first rib having a first width. The plurality of ribs may further include a second rib having a second width different from the first width.

In at least another aspect of the present disclosure, a vehicle is described. The vehicle may include one or more drive units. The vehicle may further include a battery subassembly configured to power the one or more drive units. The battery subassembly may include an enclosure configured to cover one or more battery cells. The battery subassembly may further include a tray coupled with the enclosure. The tray may include a first surface that faces the enclosure. The first surface may define i) a first modulated portion and ii) a planar portion separate from the first modulated portion. The tray may further include a second surface opposite the first surface. The battery subassembly may further include a panel coupled with the tray at the planar portion. The panel may define a second modulated portion. The battery assembly a first doubler plate that covers the panel. The vehicle may further include a skid plate coupled with the tray at the second surface.

The battery subassembly may further include a second doubler plate coupled to the tray and covering the first surface at the first modulated portion. The first modulated portion may include a plurality of ribs. The plurality of ribs may include a first rib having a first width. The plurality of ribs may further include a second rib having a second width different from the first width.

### BRIEF DESCRIPTION OF THE DRAWINGS

Certain features of the subject technology are set forth in the appended claims. However, for purpose of explanation, several embodiments of the subject technology are set forth in the following figures.

FIG. 1A and FIG. 1B illustrate schematic perspective side views of example implementations of a vehicle having a battery pack, in accordance with one or more implementations of the present disclosure.

FIG. 1C illustrates a schematic perspective view of a building having a battery pack, in accordance with one or more implementations of the present disclosure.

FIG. 2A illustrates a schematic perspective view of a battery pack, in accordance with one or more implementations of the present disclosure.

FIG. 2B illustrates schematic perspective views of various battery modules that may be included in a battery pack, in accordance with one or more implementations of the present disclosure.

FIG. 2C illustrates a cross-sectional end view of a battery cell, in accordance with one or more implementations of the present disclosure.

FIG. 2D illustrates a cross-sectional perspective view of a cylindrical battery cell, in accordance with one or more implementations.

FIG. 2E illustrates a cross-sectional perspective view of a prismatic battery cell, in accordance with one or more implementations of the present disclosure.

FIG. 2F illustrates a cross-sectional perspective view of a pouch battery cell, in accordance with one or more implementations of the present disclosure.

FIG. 3 illustrates an exploded view of an enclosure and a tray for use with a battery pack, in accordance with one or more implementations of the present disclosure.

FIG. 4 illustrates a perspective view of an example of a tray for a battery pack, in accordance with one or more implementations of the present disclosure.

FIG. 5 illustrates a perspective view of an example of a tray for a battery pack, showing additional features integrated with the tray, in accordance with one or more implementations of the present disclosure.

FIG. 6 illustrates an enlarged perspective view of the tray shown in FIG. 5, showing additional features of the tray, in accordance with one or more implementations of the present disclosure.

FIG. 7 illustrates a partial cross sectional view of a tray and a plate, showing additional features of the plate, in accordance with one or more implementations of the present disclosure.

FIG. 8 illustrates a perspective view of an alternate example of a tray for a battery pack, showing modular ribs for the tray, in accordance with one or more implementations of the present disclosure.

FIG. 9 illustrates a perspective view of an alternate example of a tray for a battery pack, showing a lattice structure integrated with the tray, in accordance with one or more implementations of the present disclosure.

FIG. 10 illustrates a perspective view of an alternate example of a tray for a battery pack, showing a honeycomb structure integrated with the tray, in accordance with one or more implementations of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The subject technology is directed to a tray that forms a lower portion of an enclosure for a battery pack. The tray may be modulated to increase stiffness to resist external loads directed toward the battery pack. Additionally, the tray includes one or more structures at the front and rear portion (of the tray) to further increase stiffness for higher energy external loads. For example, a corrugated plate is coupled to the rear portion of the tray where the tray is flat, or planar. Additionally, a doubler plate is stacked over the corrugated plate. The corrugated plate and the doubler plate are welded to an interior surface (e.g., facing the battery pack and away from the environment) such that the corrugated plate and the doubler plate are not exposed to environmental factors (e.g., water, dust, salt) that could cause corrosion and/or break down the weld joints. By modulating the tray through means such as corrugation, lattice, or honeycomb structures, the tray may include enhanced stiffness, thereby allowing the tray to be positioned closer to the battery pack and increasing the clearance between the tray and a potential ground strike (e.g., contact from an object(s)).

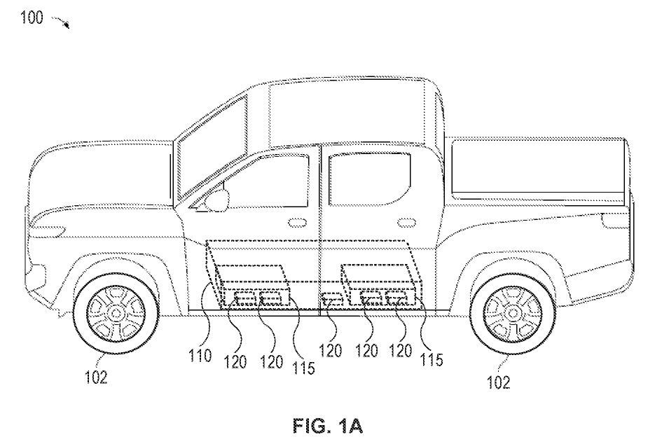

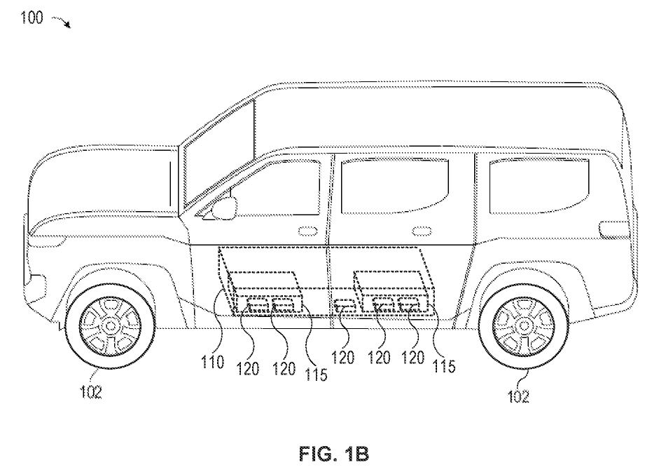

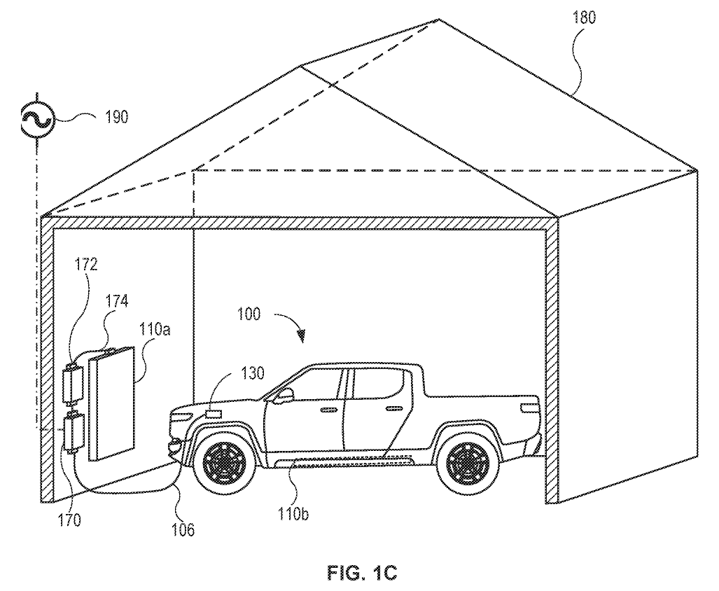

FIG. 1A illustrates an example implementation of a moveable apparatus as described herein. In the example of FIG. 1A, a moveable apparatus is implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors (e.g., one or more drive units) that drive the wheels 102 of the vehicle 100 using electric power from the battery pack 110. In one or more implementations, the vehicle 100 may also, or alternatively, include one or more engines, or motors, including chemically-powered engines, such as a gas-powered engine or a fuel cell powered motor. For example, in one or more implementations, the vehicle 100 includes one or more electric motors, and the vehicle 100 takes the form of a fully electric or partially electric (e.g., hybrid or plug-in hybrid) vehicle.

In the example of FIG. 1A, the vehicle 100 is implemented as a truck (e.g., a pickup truck) having a battery pack 110. As shown, the battery pack 110 may include one or more battery modules 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without the battery modules 115 and with the battery cells 120 mounted directly in the battery pack 110 (e.g., in a cell-to-pack configuration) and/or in other battery units that are installed in the battery pack 110. The battery pack 110 may include multiple energy storage devices that can be arranged into such as battery modules or battery units. A battery unit or module can include an assembly of cells that can be combined with other elements (e.g., structural frame, thermal management devices) that can protect the assembly of cells from heat, shock and/or vibrations.

Each of the battery cells 120 may be included a battery, a battery unit, a battery module and/or a battery pack to power components of the vehicle 100. For example, a battery cell housing of the battery cells 120 can be disposed in the battery module 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle (e.g., including one or more power outlets of the vehicle). The power stage circuit can be provided as part of the battery pack 110 or separately from the battery pack 110 within the vehicle 100.

FIG. 1B illustrates another implementation in which the vehicle 100 is implemented as a sport utility vehicle (SUV), such as an electric sport utility vehicle. In the example of FIG. 1B, the vehicle 100 may include a cargo storage area that is enclosed within the vehicle 100 (e.g., behind a row of seats within a cabin of the vehicle 100). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

In one or more implementations, the battery pack 110, battery modules 115, battery cells 120, and/or any other battery unit as described herein may also, or alternatively, be implemented as an electrical power supply and/or energy storage system in a building, such as a residential home or commercial building. For example, FIG. 1C illustrates an example in which a battery pack 110a is implemented in a building 180. The building 180 may be a residential building, a commercial building, or any other building. As shown, in one or more implementations, the battery pack 110a may be mounted to a wall of the building 180.

As shown, the battery pack 110a that is installed in the building 180 may be coupled (e.g., electrically coupled) to the battery pack 110b in the vehicle 100, such as via a cable/connector 106 that can be connected to a charging port 130 of the vehicle 100, an electric vehicle supply equipment 170 (EVSE), a power stage circuit 172, and/or a cable/connector 174. For example, the cable/connector 106 may be coupled to the EVSE 170, which may be coupled to the battery pack 110a via the power stage circuit 172, and/or may be coupled to an external power source 190. In this way, either the external power source 190 or the battery pack 110a may be used as an external power source to charge the battery pack 110b in some use cases. In one or more implementations, the battery pack 110a may also, or alternatively, be coupled (e.g., via a cable/connector 174, the power stage circuit 172, and the EVSE 170) to the external power source 190. The external power source 190 may take the form of a solar power source, a wind power source, and/or an electrical grid of a city, town, or other geographic region (e.g., electrical grid that is powered by a remote power plant). During, for example, instances when the battery pack 110b is not coupled to the battery pack 110a, the battery pack 110a may couple (e.g., using the power stage circuit 172) to the external power source 190 to charge up and store electrical energy. In some use cases, this stored electrical energy in the battery pack 110a may later be used to charge the battery pack 110b (e.g., during times when solar power or wind power is not available, in the case of a regional or local power outage for the building 180, and/or during a period of high rates for access to the electrical grid).

In one or more implementations, the power stage circuit 172 may electrically couple the battery pack 110a to an electrical system of the building 180. For example, the power stage circuit 172 may convert DC power from the battery pack 110a into AC power for one or more loads in the building 180. Exemplary loads coupled, via one or more electrical outlets coupled, to the battery pack 110a may include one or more lights, lamps, appliances, fans, heaters, air conditioners, and/or any other electrical components or electrical loads. The power stage circuit 172 may include control circuitry that is operable to switchably couple the battery pack 110a between the external power source 190 and one or more electrical outlets and/or other electrical loads in the electrical system of the building 180. In one or more implementations, the vehicle 100 may include a power stage circuit (not shown in FIG. 1C) that can be used to convert power received from the EVSE 170 to DC power that is used to power/charge the battery pack 110b, and/or to convert DC power from the battery pack 110 into AC power for one or more electrical systems, components, and/or loads of the vehicle 100.

In one or more use cases, the battery pack 110a may be used as a source of electrical power for the building 180, such as during times when solar power or wind power is not available, in the case of a regional or local power outage for the building 180, and/or during a period of high rates for access to the electrical grid, as non-limiting examples. In one or more other use cases, the battery pack 110b may be used to charge the battery pack 110a and/or to power the electrical system of the building 180 (e.g., in a use case in which the battery pack 110a is low on or out of stored energy and in which solar power or wind power is not available, a regional or local power outage occurs for the building 180, and/or a period of high rates for access to the electrical grid occurs, as non-limiting examples.

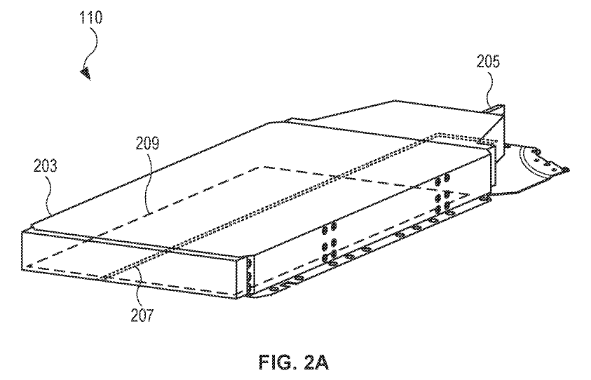

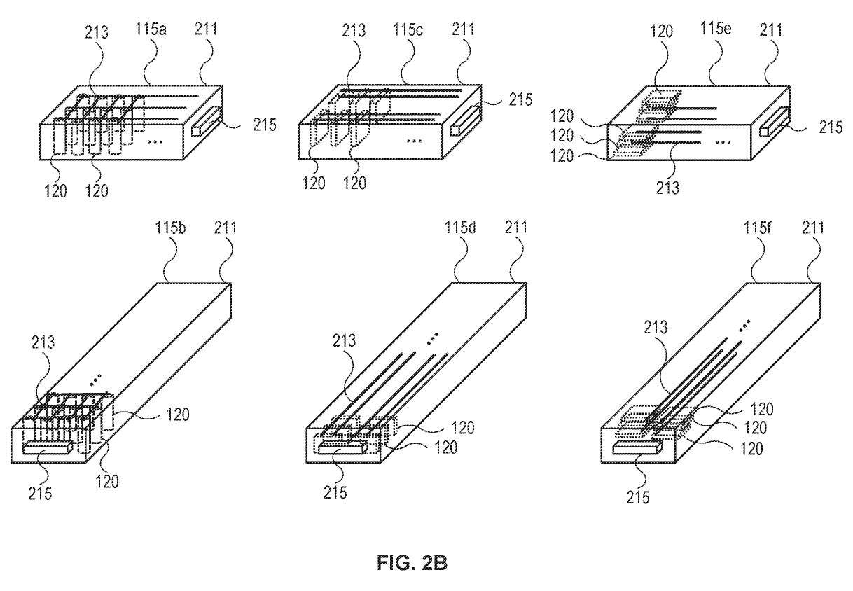

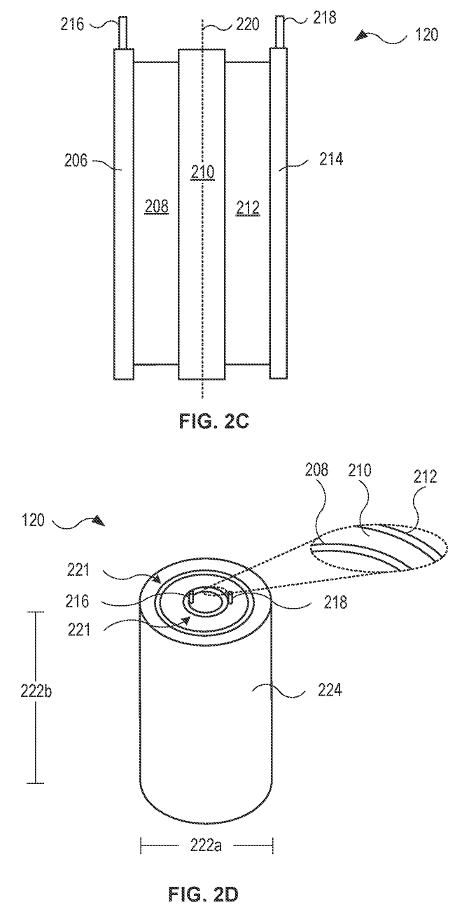

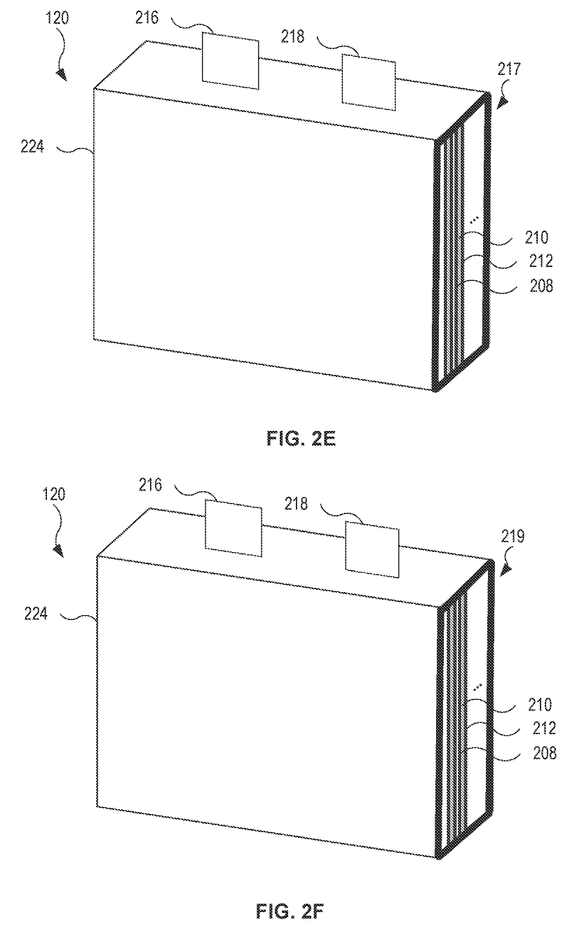

FIG. 2A illustrates an example of a battery pack 110. As shown, the battery pack 110 may include a battery pack frame 203 (e.g., a battery pack housing or pack frame). The battery pack frame 203 may house or enclose one or more battery modules and/or one or more battery cells, and/or other battery pack components of the battery pack 110. In one or more implementations, the battery pack frame 203 may include or form a shielding structure on an outer surface thereof (e.g., a bottom thereof and/or underneath one or more battery module, battery units, batteries, and/or battery cells) to protect the battery module, battery units, batteries, and/or battery cells from external conditions (e.g., if the battery pack 110 is installed in a vehicle and the vehicle is driven over rough terrain, such as off-road terrain, trenches, rocks, rivers, streams, etc.).

The battery pack 110 may include battery cells (e.g., directly installed within the battery pack 110, or within batteries, battery units, and/or battery modules as described herein) and/or battery modules, and one or more conductive coupling elements for coupling a voltage generated by the battery cells to a power-consuming component, such as the vehicle 100 (shown in FIGS. 1A, 1B, and 1C) and/or an electrical system of the building 180 (shown in FIG. 1C). For example, the conductive coupling elements may include internal connectors and/or contactors that couple together multiple battery cells, battery units, batteries, and/or multiple battery modules within the battery pack frame 203 to generate a desired output voltage for the battery pack 110. The battery pack 110 may also include one or more external connection ports, such as an electrical contact 205 (e.g., a high voltage terminal or connector). As shown, the battery pack 110 may include an electrical contact 205 may electrically couple an external load (e.g., the vehicle or an electrical system of the building) to the battery modules and/or battery cells in the battery pack 110. In this regard, an electrical cable (e.g., cable/connector 106) may be connected between the electrical contact 205 and an electrical system of a vehicle or a building, to provide electrical power to the vehicle or the building.

In one or more implementations, the battery pack 110 may include one or more thermal control structures 207 (e.g., cooling lines and/or plates and/or heating lines and/or plates). For example, thermal control structures 207 may couple thermal control structures and/or fluids to the battery modules, battery units, batteries, and/or battery cells within the battery pack frame 203, such as by distributing fluid through the battery pack 110. The thermal control structures 207 may form a part of a thermal/temperature control or heat exchange system that includes one or more thermal components 209, which may include plates or bladders that are disposed in thermal contact with one or more battery modules and/or battery cells disposed within the battery pack frame 203. The one or more thermal components 209 may be positioned in contact with one or more battery modules, battery units, batteries, and/or battery cells within the battery pack frame 203. The one or multiple thermal control structures 207 may be provided for each of several top and bottom battery module pairs.

FIG. 2B depicts various examples of battery modules that may be disposed in a battery pack (e.g., within the battery pack frame 203 of the battery pack 110, shown in FIG. 2A). In an example of FIG. 2B, a battery module 115a is shown that includes a battery module housing 211 having a rectangular cuboid shape with a length that is substantially similar to its width. In this example, the battery module 115a includes battery cells 120 implemented as cylindrical battery cells. The battery module 115a further includes rows and columns of cylindrical battery cells that are coupled together by an interconnect structure 213 (e.g., a current connector assembly or CCA). For example, the interconnect structure 213 may couple together the positive terminals of the battery cells 120, and/or couple together the negative battery terminals of the battery cells 120. As shown, the battery module 115a may further include a bus bar 215 that functions as a charge collector. For example, the bus bar 215 may be electrically coupled to the interconnect structure 213 to collect the charge generated by the battery cells 120 to provide a high voltage output from the battery module 115a.

FIG. 2B also shows a battery module 115b having an elongate shape. The battery module 115b may include a battery module housing 211 in which the length of the (e.g., extending along a direction from a front end to a rear end of the battery module housing 211) is substantially greater than a width (e.g., in a transverse direction to the direction from the front end to the rear end) of the battery module housing 211). In this regard, the battery module 115b (representative of one or more similar battery modules) may span the entire front-to-back length of a battery pack within a battery pack frame. As shown, the battery module 115a may further include an interconnect structure 213 electrically coupled to a bus bar 215, allowing the bus bar 215 may be electrically coupled to the interconnect structure 213 to collect the charge generated by battery cells 120 of the battery module 115b to provide a high voltage output from the battery module 115b.

In the implementations of battery module 115a and battery module 115a, the battery cells 120 are implemented as cylindrical battery cells. However, in other implementations, a battery module may include battery cells having other form factors, such as a battery cells having a right prismatic outer shape (e.g., a prismatic cell), or a pouch cell implementation of a battery cell. As an example, FIG. 2B also shows a battery module 115c having a battery module housing 211 with a rectangular cuboid shape with a length that is substantially similar to its width and including battery cells 120 implemented as prismatic battery cells. In this example, the battery module 115c includes rows and columns of battery cells 120 that are coupled together by an interconnect structure 213 (e.g., a current collector assembly or CCA). For example, the interconnect structure 213 may couple together the positive terminals of the battery cells 120 and/or couple together the negative battery terminals of the battery cells 120. As shown, the battery module 115c may include a bus bar 215 that functions as a charge collector. For example, the bus bar 215 may be electrically coupled to the interconnect structure 213 to collect the charge generated by the battery cells 120 to provide a high voltage output from the battery module 115c.

FIG. 2B also shows a battery module 115d including prismatic battery cells and having an elongate shape. For example, the battery module 115d includes a battery module housing 211 in which the length of the battery module housing 211 is substantially greater than a width of the battery module housing 211. In this regard, the battery module 115d (representative of one or more similar battery modules) may span the entire front-to-back length of a battery pack within a battery pack frame. As shown, the battery module 115d may also include an interconnect structure 213 and a bus bar 215 electrically coupled to the interconnect structure 213. For example, the bus bar 215 may be electrically coupled to the interconnect structure 213 to collect the charge generated by the battery cells 120 to provide a high voltage output from the battery module 115d.

As another example, FIG. 2B also shows a battery module 115e having a battery module housing 211 having a rectangular cuboid shape with a length that is substantially similar to its width. The battery module housing 211 may carry battery cells 120, each of which being implemented as pouch battery cells. In this example, the battery module 115e includes rows and columns of pouch battery cells that are coupled together by an interconnect structure 213 (e.g., a current collector assembly or CCA). For example, the interconnect structure 213 may couple together the positive terminals of the battery cells 120 and couple together the negative battery terminals of the battery cells 120. As shown, the battery module 115e may also include a bus bar 215 electrically coupled to the interconnect structure 213. For example, the bus bar 215 may be electrically coupled to the interconnect structure 213 to collect the charge generated by the battery cells 120 to provide a high voltage output from the battery module 115e.

FIG. 2B also shows a battery module 115f including pouch battery cells and having an elongate shape. For example, the battery module 115d includes a battery module housing 211 in which the length of the battery module housing 211 is substantially greater than a width of the battery module housing 211. In this regard, the battery module 115d (representative of one or more similar battery modules) may span the entire front-to-back length of a battery pack within a battery pack frame. In this regard, the battery module 115f (representative of one or more similar battery modules) may span the entire front-to-back length of a battery pack within a battery pack frame. As shown, the battery module 115f may also include an interconnect structure 213 and a bus bar 215 electrically coupled to the interconnect structure 213. For example, the bus bar 215 may be electrically coupled to the interconnect structure 213 to collect the charge generated by the battery cells 120 to provide a high voltage output from the battery module 115f.

In various implementations, a battery pack (e.g., battery pack 110 shown in FIG. 2A) may be provided with one or more of any of the battery modules 115a, 115b, 115c, 115d, 115e, and 115f. In one or more other implementations, a battery pack may be provided without any of the battery modules 115a, 115b, 115c, 115d, 115e, and 115f (e.g., in a cell-to-pack implementation).

In one or more implementations, battery modules in any of the implementations of FIG. 2B may be coupled (e.g., in series) to a current collector of a battery pack. In one or more implementations, the current collector may be coupled, via a high voltage harness, to one or more external connectors on a battery pack (e.g., electrical contact 205 of the battery pack 110, shown in FIG. 2A). In one or more implementations, a battery pack may be provided without any battery modules 115. For example, in a cell-to-pack configuration, the battery cells 120 are arranged directly into a battery pack without assembly into a battery module (e.g., without including the battery module housing 211). For example, a battery pack frame of a battery pack (e.g., the battery pack frame 203 of the battery pack 110 shown in FIG. 2A) may include or define a plurality of structures for positioning of the battery cells 120 directly within the battery pack frame.

FIG. 2C illustrates a cross-sectional end view of a portion of a battery cell 120. As shown, the battery cell 120 may include an anode 208, an electrolyte 210, and a cathode 212. As shown, the anode 208 may include or be electrically coupled to a first current collector 206 (e.g., a metal layer such as a layer of copper foil or other metal foil). Also, the cathode 212 may include or be electrically coupled to a second current collector 214 (e.g., a metal layer such as a layer of aluminum foil or other metal foil). The battery cell 120 may further include a terminal 216 (e.g., a negative terminal) coupled to the anode 208 (e.g., via the first current collector 206) and a terminal 218 (e.g., a positive terminal) coupled to the cathode (e.g., via the second current collector 214). In various implementations, the electrolyte 210 may take the form of a liquid electrolyte layer or a solid electrolyte layer. In one or more implementations in which the electrolyte 210 is a liquid electrolyte layer, the battery cell 120 may include a separator layer 220 that separates the anode 208 from the cathode 212. In one or more implementations in which the electrolyte 210 is a solid electrolyte layer, the electrolyte 210 may function as both separator layer and an electrolyte layer.

In one or more implementations, the battery cell 120 may be implemented as a lithium ion battery cell in which the anode 208 is formed from a carbonaceous material (e.g., graphite or silicon-carbon). In these implementations, lithium ions can move from the anode 208, through the electrolyte 210, to the cathode 212 during discharge of the battery cell 120 (e.g., and through the electrolyte 210 from the cathode 212 to the anode 208 during charging of the battery cell 120). For example, the anode 208 may be formed from a graphite material that is coated on a copper foil corresponding to the first current collector 206. In these lithium ion implementations, the cathode 212 may be formed from one or more metal oxides (e.g., a lithium cobalt oxide, a lithium manganese oxide, a lithium nickel manganese cobalt oxide (NMC), or the like) and/or a lithium iron phosphate. In an implementation in which the battery cell 120 is implemented as a lithium-ion battery cell, the electrolyte 210 may include a lithium salt in an organic solvent.

The separator layer 220 may be formed from one or more insulating materials (e.g., a polymer such as polyethylene, polypropylene, polyolefin, and/or polyamide, or other insulating materials such as rubber, glass, cellulose or the like). The separator layer 220 may prevent contact between the anode 208 and the cathode 212, and may be permeable to the electrolyte 210 and/or ions within the electrolyte 210. In one or more implementations, the battery cell 120 may be implemented as a lithium polymer battery cell having a dry solid polymer electrolyte and/or a gel polymer electrolyte.

Although some examples are described herein in which the battery cell 120 is implemented as lithium-ion battery cells, the battery cell 120 may be implemented using other battery cell technologies, such as nickel-metal hydride battery cells, lead-acid battery cells, and/or ultracapacitor cells. For example, in a nickel-metal hydride battery cell, the anode 208 may be formed from a hydrogen-absorbing alloy and the cathode 212 may be formed from a nickel oxide-hydroxide. In the example of a nickel-metal hydride battery cell, the electrolyte 210 may be formed from an aqueous potassium hydroxide in one or more examples.

The battery cell 120 may be implemented as a lithium sulfur battery cell in one or more other implementations. For example, in a lithium sulfur battery cell, the anode 208 may be formed at least in part from lithium, the cathode 212 may be formed from at least in part form sulfur, and the electrolyte 210 may be formed from a cyclic ether, a short-chain ether, a glycol ether, an ionic liquid, a super-saturated salt-solvent mixture, a polymer-gelled organic media, a solid polymer, a solid inorganic glass, and/or other suitable electrolyte materials. In various implementations, the anode 208, the electrolyte 210, and the cathode 212 can be packaged into a battery cell housing having any of various shapes, and/or sizes, and/or formed from any of various suitable materials. For example, the battery cell 120 may include a cylindrical, rectangular, square, cubic, flat, pouch, elongated, or prismatic outer shape.

As depicted in FIG. 2D, for example, a battery cell 120 may be implemented as a cylindrical cell. Accordingly, the battery cell 120 includes dimension 222a (e.g., cylinder diameter, battery cell diameter) and a dimension 222b (e.g., cylinder length). The battery cell 120, and other battery cells described herein, may include dimensional information derived from a 4-number code. For example, in some embodiments, the battery cell 120 includes an XXYY battery cell, in which “XX” refers to the dimension 222a in millimeters (mm) and “YY” refers to the dimension in mm. Accordingly, when the battery cell 120 includes a “2170” battery cell, the dimension 222a is 21 mm and the dimensions 222b is 70 mm. Alternatively, when the battery cell 120 includes a “4680” battery cell, the dimension 222a is 46 mm and the dimensions 222b is 80 mm. The foregoing examples of dimensional characteristics for the battery cell 120 should not be construed as limiting, and the battery cell 120, and other battery cells described herein with a cylindrical form factor, may include various dimension. For example, the dimension 222a and the dimension 222b may be greater than 46 mm and 80 mm, respectively.

FIG. 2D illustrates a battery cell 120 that includes a cell housing 224 having a cylindrical outer shape. As shown in the enlarged view, the anode 208, the electrolyte 210, and the cathode 212 may be rolled into one or more windings 221. The one or more windings 221 may include one or more substantially cylindrical windings, as a non-limiting example. As shown, one or more windings 221 of the anode 208, the electrolyte 210, and the cathode 212 (e.g., and/or one or more separator layers such as separator layer 220 shown in FIG. 2C) may be disposed within the cell housing 224. For example, a separator layer may be disposed between adjacent ones of the one or more windings 221. Additionally, the battery cell 120 in the cylindrical cell implementation of FIG. 2D includes a terminal 216 and a terminal 218. The terminal 218 may include a first polarity terminal, such as a positive terminal, which is coupled to the cathode 212. The terminal 216 may include a second polarity terminal, such as a negative terminal, which is coupled to the anode 208. The terminals 216 and 218 can be made from electrically conductive materials to carry electrical current from the battery cell 120 directly or indirectly (e.g., via a current carrier assembly, a bus bar, and/or other electrical coupling structures) to an electrical load, such as a component or system of a vehicle or a building shown and/or described herein. However, the cylindrical cell implementation of FIG. 2D is merely illustrative, and other implementations of the battery cells 120 are contemplated.

FIG. 2E illustrates an example in which the battery cell 120 is implemented as a prismatic cell. As shown, the battery cell 120 may include a cell housing 224 having a right prismatic outer shape. Also, one or more layers of the anode 208, the cathode 212, and the electrolyte 210 disposed therebetween may be disposed (e.g., with separator materials between the layers) within the cell housing 224. As examples, multiple layers of the anode 208, electrolyte 210, and cathode 212 can be stacked (e.g., with separator materials between each layer), or a single layer of the anode 208, electrolyte 210, and cathode 212 can be formed into a flattened spiral shape and provided in the cell housing 224. The cell housing 224 may include a cross-sectional width 217 that is relatively thick and is formed from a rigid material. For example, the cell housing 224 may be formed from a welded, stamped, deep drawn, and/or impact extruded metal sheet, such as a welded, stamped, deep drawn, and/or impact extruded aluminum sheet. The cross-sectional width 217 of the cell housing 224 may be as much as, or more than 1 millimeter (mm) to provide a rigid housing for the prismatic battery cell. In one or more implementations, a terminal 216 and a terminal 218 in the prismatic cell implementation of FIG. 2E may be formed from a feedthrough conductor that is insulated from the cell housing 224 (e.g., a glass to metal feedthrough) as the conductor passes through to cell housing 224 to expose the terminal 216 and the terminal 218 outside the cell housing 224 in order to contact an interconnect structure (e.g., interconnect structure 213 shown in FIG. 2B). However, this implementation of FIG. 2E is also illustrative and yet other implementations of the battery cell 120 are contemplated.

FIG. 2F illustrates an example in which the battery cell 120 is implemented as a pouch cell. As shown, the battery cell 120 may include a cell housing 224 that forms a flexible or malleable pouch housing. One or more layers of the anode 208, the cathode 212, and the electrolyte 210 disposed therebetween may be disposed (e.g., with separator materials between the layers) within the cell housing 224. In the implementation of FIG. 2F, the cell housing 224 may include a cross-sectional width 219 that is relatively thin. For example, the cell housing 224 in the implementation of FIG. 2F may be formed from a flexible or malleable material (e.g., a foil, such as a metal foil, or film, such as an aluminum-coated plastic film). The cross-sectional width 219 of the cell housing 224 may be as low as, or less than, 0.1 mm, 0.05 mm, 0.02 mm, or 0.01 mm to provide flexible or malleable housing for the pouch battery cell. In one or more implementations, a terminal 216 and a terminal 218 in the pouch cell implementation of FIG. 2F may be formed from conductive tabs (e.g., foil tabs) that are coupled (e.g., welded) to the anode 208 and the cathode 212 respectively, and sealed to the pouch that forms the cell housing 224 in these implementations. In the examples of FIGS. 2C, 2E, and 2F, the terminal 216 and the terminal 218 are formed on the same side (e.g., a top side) of the battery cell 120. However, this is merely illustrative and, in other implementations, the terminal 216 and the terminal 218 may formed on two different sides (e.g., opposing sides, such as a top side and a bottom side) of the battery cell 120. The terminal 216 and the terminal 218 may be formed on a same side or difference sides of the cylindrical cell of FIG. 2D in various implementations.

In one or more implementations, a battery module, a battery pack, a battery unit, or any other battery may include some battery cells that are implemented as solid-state battery cells and other battery cells that are implemented with liquid electrolytes for lithium-ion or other battery cells having liquid electrolytes. In one or more implementations, one or more of the battery cells may be included a battery module or a battery pack, such as to provide an electrical power supply for components of a vehicle and/or a building previously described, or any other electrically powered component or device. A cell housing of the battery cell can be disposed in the battery module, the battery pack, or installed in any of the vehicle, the building, or any other electrically powered component or device.

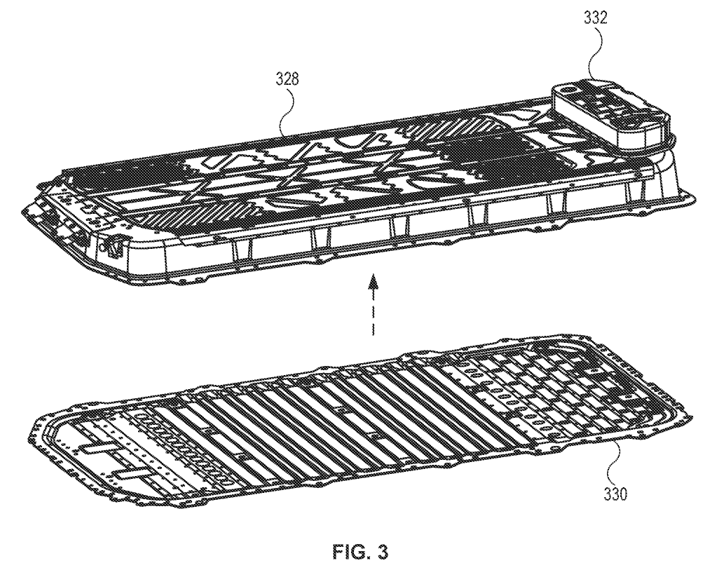

FIG. 3 illustrates an exploded view of an enclosure 328 and a tray 330 for use with a battery pack (e.g., battery pack 110 shown in FIG. 1A), in accordance with one or more implementations of the present disclosure. The enclosure 328, or housing, may be utilized for covering one or more battery modules (e.g., battery module 115 shown in FIG. 1A) of a battery pack, and accordingly, for covering one or more battery cells (e.g., battery cell 120 shown in FIG. 1A). In this regard, the enclosure 328 may form an internal volume, or cavity, to receive the battery module(s). The enclosure 328 and the tray 330, along with one or more battery module(s), may form in part a battery subassembly. An enclosure 332 may be attached to the enclosure 328. The enclosure 332 may provide a housing for a high voltage distribution box and other circuitry for monitoring and/or managing a battery pack covered by the enclosure 328.

The tray 330 is designed to assemble with the enclosure 328 to enclose the battery module(s), including one or more battery cells of the battery module(s). The tray 330 may include various structural enhancements and added structural components. This will be shown and described in further detail below. Based on the position of the tray 330 within a vehicle (e.g., vehicle 100 shown in FIG. 1A), the tray 330 may provide protection to the battery module(s) against ground strikes from foreign objects that could otherwise contact and damage the battery module(s) during operation of the vehicle.

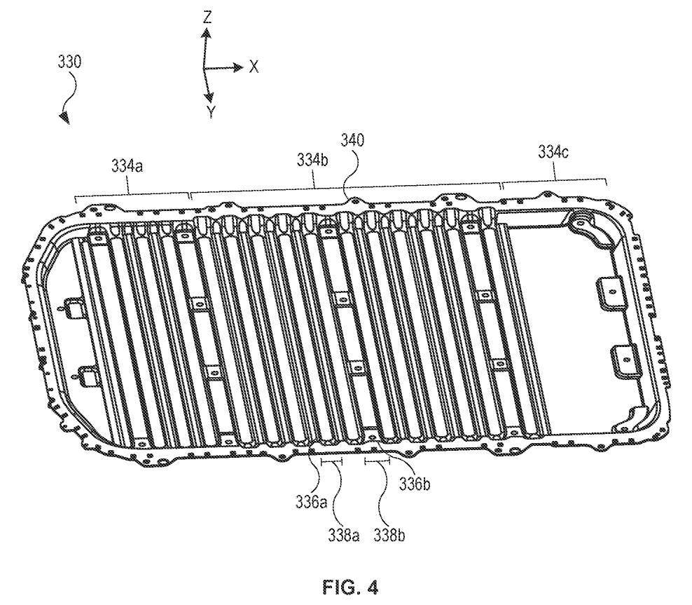

FIG. 4 illustrates a perspective view of an example of a tray 330 for a battery pack, in accordance with one or more implementations of the present disclosure. In one or more implementations, the tray 330 include a metal(s), such as steel. However, other metals (e.g., aluminum, aluminum alloy) may be used. When the tray 330 is formed from a metal(s), the tray 330 may be formed through a stamping operation, as a non-limiting example. Alternatively, in one or more implementations, the tray 330 is formed from one or more non-metals (e.g., plastic, resin) and is formed through a molding operation, as a non-limiting example.

The tray 330 may include various portions, or regions, with different features. For example, the tray 330 may include a portion 334a, a portion 334b, and a portion 334b. The portion 334a and the portion 334b may each include several ribs. For example, as shown in FIG. 4, the portion 334b includes a rib 336a and a rib 336b (each representative of one or more additional ribs of the portions 334a and 334b). In this regard, the portion 334a and the portion 334b may each be referred to as a modulated portion. Further, based in part on the ribs 336a and 336b (as well as ribs in the portion 334a), the portion 334a and the portion 334b may be referred to as a corrugated portion. Although not shown, the portion 334a may be covered by a plate.

The ribs in each of the portions 334a and 334b may be of different widths (e.g., as measured along the X-axis in Cartesian coordinates). For example, the rib 336a and the rib 336b may include a width 338a and a width 338b, respectively. As shown, the width 338a is different from the width 338b. The width 338a may be less than the width 338b, or conversely, the width 338b may be greater than the width 338a. The respective widths of the ribs may be controlled through a manufacturing process of the tray 330 in order to, for example, create a desired stiffness of the tray 330 and/or to provide locations for openings, or holes, for fasteners (not shown in FIG. 4). For example, the rib 336b, having a relatively greater width, for an opening (shown, not labeled). Also, the different in width sizes may be utilized to receive one or more plates (not shown in FIG. 4).

Additionally, the portion 334c (separate from the portion 334a and the portion 334b) may take the form of a planar portion. In this regard, the portion 334c may be substantially flat. As a result, the portion 334c may be designed to couple with one or more additional structures used to provide increased stiffness against higher energy loads to the tray 330. This will be shown and described in further detail below.

Based on the tray 330 having some portions (e.g., portions 334a and 334b) that are modulated (e.g., corrugated) and another portion (e.g., portion 334c) that is planar, the tray 330 may take the form of an asymmetric body, with the asymmetry defined by, for example, a line along the Y-axis passing through a center point 340 of the tray 330. The asymmetric nature may be due in part to the potential for higher or lower energy loads to the tray 330. For example, the portion 334b (e.g., center portion, central portion) may be predicted to incur relatively lower energy loads. Conversely, the portion 334a (e.g., front portion) may be predicted to incur relatively higher energy loads than at the portion 334b, and as a result, may receive a plate. Further, the portion 334c (e.g., rear portion) may be predicted to incur relatively higher energy loads than at the portion 334a, and as a result, may receive multiple plates. The plates will be shown and described in further detail below.

Based on the manufacturing of the tray 330, the plates 340a and 340b, and the panel 340, the assembly of these components may be scalable not only for mass production but also for different sizes (e.g., larger, smaller) as well as different stiffnesses. Also, by selecting certain portions to include certain stiffnesses, the overall cost and manufacturing time may be reduced.

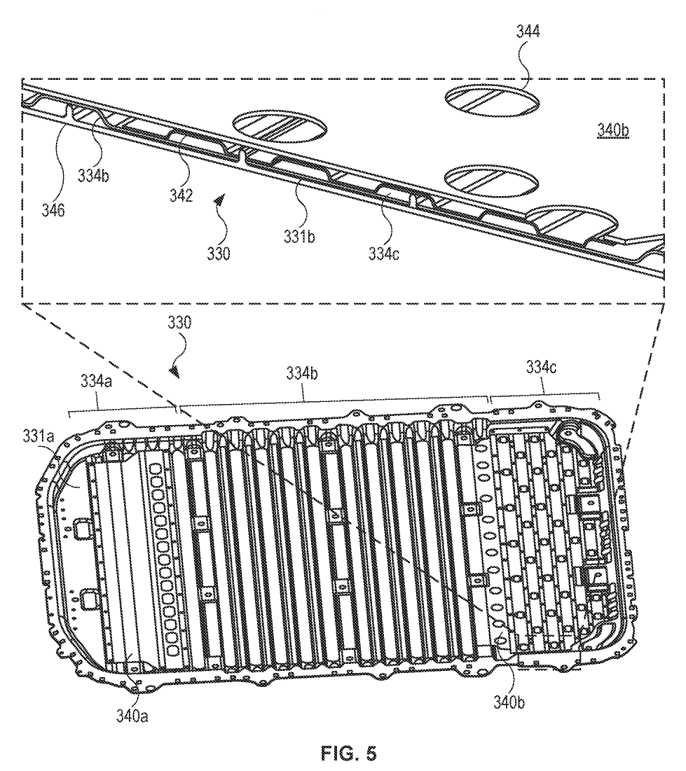

FIG. 5 illustrates a perspective view of an example of a tray 330 for a battery pack, showing additional features integrated with the tray 330, in accordance with one or more implementations of the present disclosure. Several additional plates may be added to a surface 331a the tray 330, which may provide increase/enhance the overall stiffness of the tray 330. For example, a plate 340a and a plate 340b may be coupled to the tray 330 at the portion 334a and the portion 334c, respectively. In one or more implementations, each of the plates 340a and 340b takes the form of a doubler plate. In this regard, the tray 330 may be strengthened, and thus provide reinforcement and greater resistance against loads to the tray 330 at the portions 334a and 334c of the tray 330.

As shown in the enlarged view, additional plates may be disposed on the tray 330. For example, a panel 342 may couple to the tray 330 at the portion 334c. Moreover, the panel 342 may be positioned between the tray 330 (at the portion 334c) and the plate 340b. In one or more implementations, the panel 342 takes the form of a modulated panel. In this regard, the panel 342 may take the form of a corrugated panel with several ribs. In order to secure the panel 342 to the tray 330, the panel 342 may be welded to the tray 330. The plate 340b may include an opening 344 (representative of additional openings) that provides a place through which a welding tool (not shown in FIG. 5) may pass through the plate 340b to weld the panel 342 with the tray 330.

Also, a plate 346 may attach to a surface 331b (e.g., a lowermost surface) of the tray 330, with the surface 331b being opposite the surface 331a. The plate 346 may take the form of a skid plate that provides additional protection against ground strikes. The plate 346 may include a planar surface that enhances the overall aerodynamics of a vehicle (e.g., vehicle 100 shown in FIG. 1). The plate 346 is designed to be removed and replaced in the event of damage to the plate 346 caused by a ground strike.

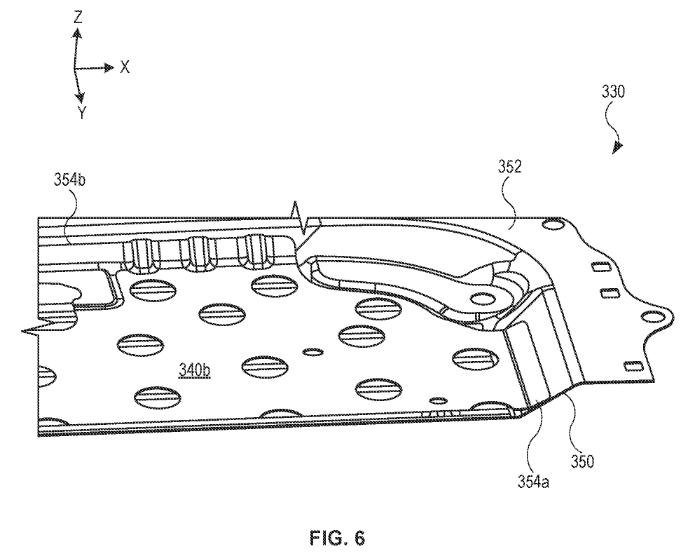

FIG. 6 illustrates an enlarged perspective view of the tray 330 shown in FIG. 5, showing additional features of the tray 330, in accordance with one or more implementations of the present disclosure. As shown, the tray 330 may include a wall 350. In one or more implementations, the wall 350 takes the form of a diagonal wall that extends around each of the portions 334a, 334b, and 334c (e.g., shown in FIG. 4). Also, the tray 330 may include a flange portion 352, or flange, that extends from the wall 350. The flange portion 352 may define a perimeter, or outer region, of the tray 330, and accordingly, the flange portion 352 may surround the wall 350.

Some of the plates may be coupled with (e.g., welded to) the tray 330 at the wall 350 of the tray 330. For example, the plate 340b may include a wall 354a and wall 354b coupled with the wall 350. Based in part on the walls 354a and 354b of the plate 340b coupling to the wall 35 and extending to laterally along the X- and Y-axes, the overall stiffness of the tray 330 may be enhanced (e.g., increased). The plate 340b may function as a tension member to maintain the shape and structural integrity of the tray 330, including at the wall 350. Beneficially, the tray 330 may be placed relatively close to a battery module(s) (not shown in FIG. 6), thereby reducing air gaps, or spaces, between the tray 330 and the battery module(s) and increasing the distance between the tray 330 and potential ground strike objects.

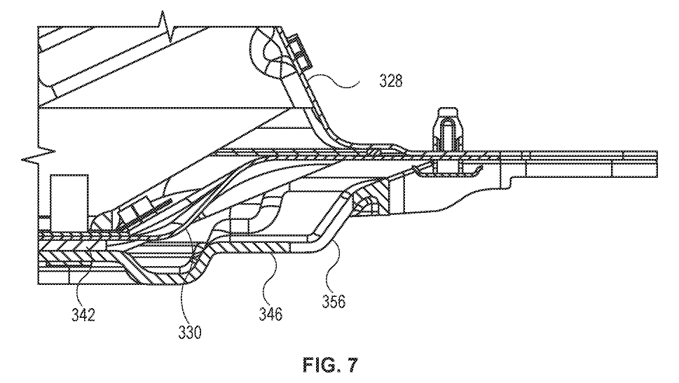

FIG. 7 illustrates a partial cross sectional view of a tray 330 and a plate 346, showing additional features of the plate, in accordance with one or more implementations of the present disclosure. As shown, the enclosure 328 is coupled with the tray 330. The plate 346 may include an opening 356 designed to receive a cover (not shown in FIG. 7). Based on part on the modulation (e.g., corrugation) of the tray 330, additional space or volume is provided for the cover. Also, prior to securing with the tray 330, the panel 342 may “float” or be un-affixed to the tray 330 (e.g., prior to a welding operation), due in part to the modulation (e.g., corrugation) of the panel 342. This may facilitate securing the panel 342 with the tray 330.

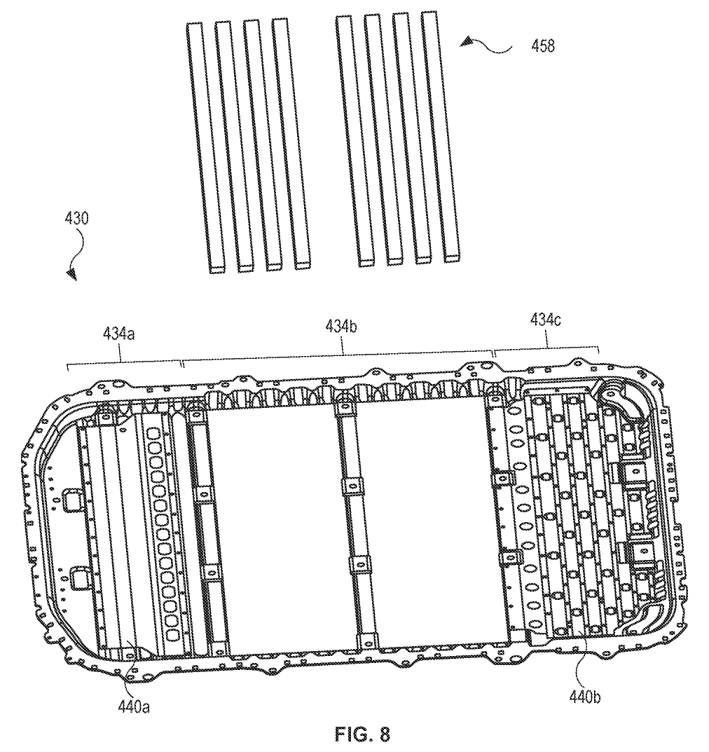

FIGS. 8-10 show alternate examples of trays with different features. The trays shown and described in FIGS. 8-10 may include at least some of the features of the trays (e.g., tray 330 shown in FIG. 3) previously shown and/or described.

FIG. 8 illustrates a perspective view of an alternate example of a tray 430 for a battery pack, showing modular ribs for the tray, in accordance with one or more implementations of the present disclosure. The tray 430 may include a portion 434a, a portion 434b, and a portion 434b, with a cover 440a and a cover 440b coupled with the portion 434a and 434c, respectively, of the tray 430. The portion 434b (e.g., central portion) of the tray 430 may include one or planar portions designed to receive ribs 458 that define a modulated portion of the tray 430. The ribs 458 may be installed (e.g., welded, fastened, adhered) to the portion 434b. The ribs 458 may vary in size and/or shape, thus giving the tray 430 a specified stiffness at the portion 434b.

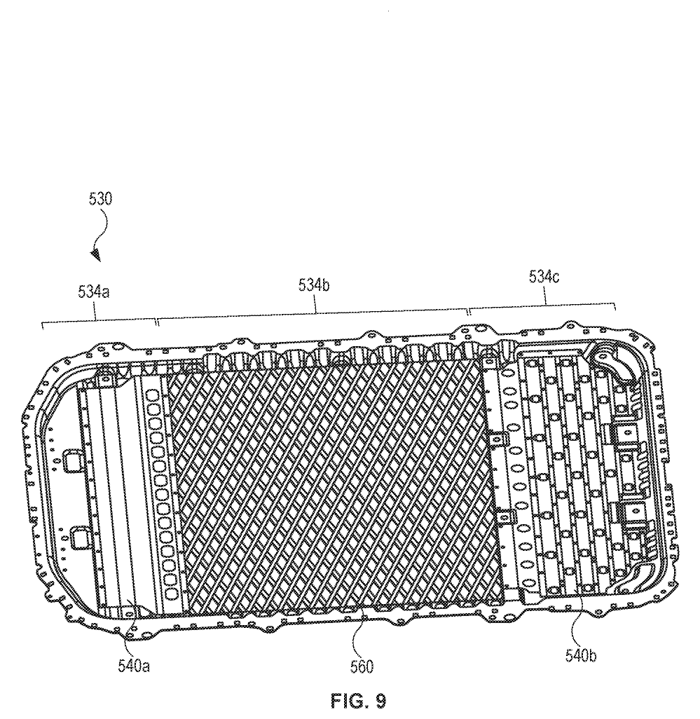

FIG. 9 illustrates a perspective view of an alternate example of a tray 530 for a battery pack, showing a lattice structure integrated with the tray, in accordance with one or more implementations of the present disclosure. The tray 530 may include a portion 534a, a portion 534b, and a portion 534b, with a cover 540a and a cover 540b coupled with the portion 534a and 534c, respectively, of the tray 530. The portion 534b (e.g., central portion) of the tray 530 may include a lattice structure 560 that defines a modulated portion of the tray 530. The lattice structure 560 is designed to enhance the stiffness of the tray 530 at the portion 534b.

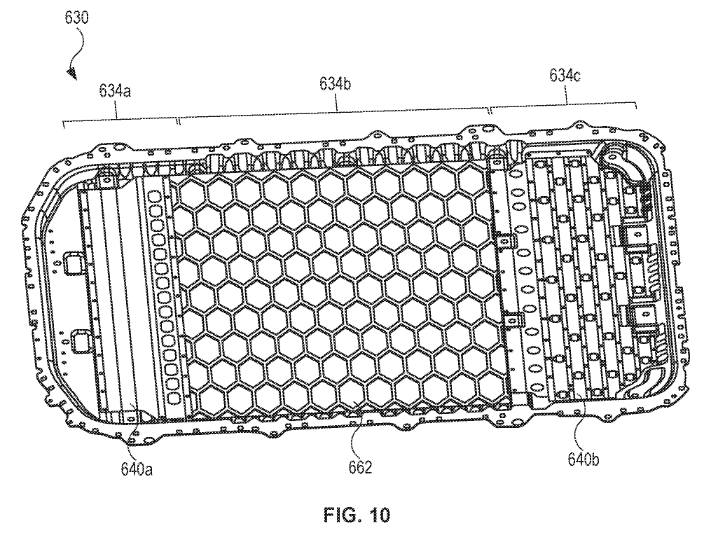

FIG. 10 illustrates a perspective view of an alternate example of a tray 630 for a battery pack, showing a honeycomb structure integrated with the tray, in accordance with one or more implementations of the present disclosure. The tray 630 may include a portion 634a, a portion 634b, and a portion 634b, with a cover 640a and a cover 640b coupled with the portion 434a and 634c, respectively, of the tray 630. The portion 634b (e.g., central portion) of the tray 430 may include a honeycomb structure 662 that defines a modulated portion of the tray 630. The honeycomb structure 662 is designed to enhance the stiffness of the tray 630 at the portion 634b.

Aspects of the subject technology can help extend the life of a battery in a vehicle by reducing the likelihood of damage to the battery. This can help facilitate the functioning of and/or proliferation of batteries, which can positively impact the climate by reducing greenhouse gas emissions.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being "connected" or "coupled" to another element, it is to be understood that the elements can be directly connected to the other element, or have intervening elements present between the elements. In contrast, when an element is referred to as being "directly connected" or "directly coupled" to another element, it should be understood that no intervening elements are present in the "direct" connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An apparatus, comprising:
a tray configured to couple with an enclosure for a battery pack, the tray comprising:
a first modulated portion; and
a planar portion separate from the first modulated portion;
a panel coupled with the tray at the planar portion, the panel defining a second modulated portion; and
a first doubler plate that covers the panel.

2. The apparatus of claim 1, wherein:
the tray comprises a first wall; and
the first doubler plate comprises a second wall welded to the first wall.

3. The apparatus of claim 2, wherein the first wall surrounds the first modulated portion and the planar portion.

4. The apparatus of claim 2, wherein the first wall comprises a diagonal wall.

5. The apparatus of claim 1, further comprising a second doubler plate coupled to the tray at the first modulated portion.

6. The apparatus of claim 1, wherein the panel is welded to the planar portion.

7. The apparatus of claim 1, wherein the first modulated portion comprises a plurality of ribs, the plurality of ribs comprising:
a first rib having a first width, and
a second rib having a second width different from the first width.

8. The apparatus of claim 7, wherein the first width is greater than the second width.

9. The apparatus of claim 8, wherein the first rib comprises an opening configured to receive a fastener.

10. The apparatus of claim 8, wherein the tray defines an asymmetric body based on the first modulated portion and the planar portion.

11. A battery subassembly, comprising:
an enclosure configured to cover one or more battery cells;
a tray coupled with the enclosure, the tray comprising:
a first surface that faces the enclosure, the first surface defining i) a first modulated portion and ii) a planar portion separate from the first modulated portion, and
a second surface opposite the first surface, wherein the enclosure and the tray combine to enclose the one or more battery cells; and
a skid plate coupled with the tray at the second surface.

12. The battery subassembly of claim 11, further comprising:
a panel coupled with the tray at the planar portion, the panel defining a second modulated portion; and
a first doubler plate that covers the panel.

13. The battery subassembly of claim 12, further comprising a second doubler plate coupled to the tray and covering the first surface at the first modulated portion.

14. The battery subassembly of claim 12, wherein:
the tray further comprises a first wall; and
the first doubler plate comprises a second wall welded to the first wall.

15. The battery subassembly of claim 14, wherein the first wall comprises a diagonal wall.

16. The battery subassembly of claim 15, wherein the tray further comprises a flange portion extending from the diagonal wall and coupled with the enclosure.

17. The battery subassembly of claim 11, wherein the first modulated portion defines a corrugated portion having a plurality of ribs.

18. The battery subassembly of claim 17, wherein the plurality of ribs comprise:
a first rib having a first width, and
a second rib having a second width different from the first width.

19. A vehicle, comprising:
one or more drive units;
a battery subassembly configured to power the one or more drive units, the battery subassembly comprising:
an enclosure configured to cover one or more battery cells;
a tray coupled with the enclosure, the tray comprising:
a first surface that faces the enclosure, the first surface defining i) a first modulated portion and ii) a planar portion separate from the first modulated portion, and
a second surface opposite the first surface;
a panel coupled with the tray at the planar portion, the panel defining a second modulated portion, and
a first doubler plate that covers the panel; and
a skid plate coupled with the tray at the second surface.

20. The vehicle of claim 19, wherein:
the battery subassembly further comprises a second doubler plate coupled to the tray and covering the first surface at the first modulated portion, and
the first modulated portion comprises a plurality of ribs, the plurality of ribs comprising:
a first rib having a first width, and
a second rib having a second width different from the first width.
